(19) United States
(12) Patent Application Publication
(10) Pub. No.: US 2019/0259070 A1
(43) Pub. Date: Aug. 22, 2019

(54) ADVERTISING INFORMATION PUSHING METHOD, DEVICE AND SYSTEM, SERVER, AND COMPUTER READABLE MEDIUM

(71) Applicant: SUZHOU DEEPLEAPER INFORMATION AND TECHNOLOGY COMPANY LIMITED, Suzhou, Jiangsu (CN)

(72) Inventors: Dongjun Li, Beijing (CN); Ran Wang, Beijing (CN)

(21) Appl. No.: 16/068,885

(22) PCT Filed: Jul. 26, 2017
(86) PCT No.: PCT/CN2017/094533

§ 371 Date: Jul. 9, 2018

(30) Foreign Application Priority Data
Oct. 20, 2016 (CN) 201610916416.7

(51) Int. Cl. G06Q 30/02

(52) U.S. Cl. CPC G06Q 30/0271; G06Q 30/0277

(57) ABSTRACT

An advertising information pushing method, device and system, a server and a computer readable medium are provided, relating to the technical field of computer applications. One method comprises acquiring an access request of a user; carrying out semantic analysis on reading contents corresponding to the access request to obtain interest information of the user; acquiring advertising information matched with the interest information; and pushing the advertising information to a client side. In such methods, the advertising information matched with the interest information is obtained according to the interest information, and thus pushed to clients, ensuring to a great extent that the advertisements, pushed to the users, interest the users, thereby guaranteeing the effectiveness of the advertisements.

This application is a 371 U.S. National Phase of International application No. PCT/CN2017/094533, filed Jul. 26, 2017, and claims benefit/priority of Chinese patent application No. CN201610916416.7, filed Oct. 20, 2016, entitled “Advertising Information Pushing Method, Device, and System”, contents of all of which are incorporated herein by reference in entirety.

### TECHNICAL FIELD

The present disclosure relates to the technical field of computer application, in particular to a method, a device and a system for pushing advertising information (i.e. advertising information pushing method, device and system), a server, and a computer readable medium.

### BACKGROUND ART

When pushing advertising information on smart terminals such as computers and cellphones, a fixed advertising position is usually used, i.e. preset advertising information is displayed at a fixed position in a display interface; alternatively, the advertising information is displayed in a form of a pop-up page; sometimes, the advertising content may also be inserted in content information flow. These advertising information pushing modes are blunt, and in many situations, the advertising information, if not needed by users, cannot arouse interests of the users, leading to poor pushing effectiveness of the advertisements.

Therefore, a method capable of pushing advertising information according to the reading contents of users and the interests of the users becomes a problem demanding prompt solution.

### SUMMARY

In view of this, an object of embodiments of the present disclosure is to provide advertising information pushing method, device, and system, capable of pushing advertising information according to reading contents of users and interests of users, improving pushing effectiveness of advertisements.

In a first aspect, an embodiment of the present disclosure provides an advertising information pushing method, including:

acquiring an access request of a user; carrying out semantic analysis on reading contents corresponding to the access request to obtain interest information of the user; acquiring advertising information matched with the interest information; and pushing the advertising information to a client side.

In combination with the first aspect, an embodiment of the present disclosure provides a first possible example of the first aspect, wherein the following way is used for carrying out semantic analysis on reading contents corresponding to the access request: carrying out the semantic analysis on the reading contents by natural language processing, with a result of the natural language processing as the interest information.

In combination with the first aspect, an embodiment of the present disclosure provides a second possible example of the first aspect, wherein the following way is used for carrying out semantic analysis on reading contents corresponding to the access request: carrying out the semantic analysis on the reading contents by machine learning, with a result of the machine learning as the interest information.

In combination with the first aspect, an embodiment of the present disclosure provides a third possible example of the first aspect, wherein the following way is used for carrying out semantic analysis on reading contents corresponding to the access request: and performing retrieval on the reading contents according to one of preset keywords, wherein when a retrieved result satisfies a first preset condition, category tags corresponding to the keyword are taken as the interest information of the user.

In combination with the first aspect, an embodiment of the present disclosure provides a fourth possible example of the first aspect, wherein the first preset condition includes: a condition where number of occurrences that the keyword is found in the reading contents is greater than or equal to a first preset number.

In combination with the first aspect, an embodiment of the present disclosure provides a fifth possible example of the first aspect, wherein the first preset condition includes: a condition where each of the keywords is further associated with at least one supplementary keyword; and number of occurrences that the keyword is found in the reading contents is greater than or equal to a second preset number, and the reading contents at least include one supplementary keyword.

In combination with the first aspect, an embodiment of the present disclosure provides a sixth possible example of the first aspect, wherein the following way is used for carrying out semantic analysis on reading contents corresponding to the access request: acquiring, according to the reading contents, category tags added in advance for the reading contents, with the category tags as the interest information of the user.

In combination with the first aspect, an embodiment of the present disclosure provides a seventh possible example of the first aspect, wherein it further includes: adding in advance at least one tag for each piece of advertising information, wherein the step of acquiring advertising information matched with the interest information includes: matching the interest information with the tag of the advertising information, wherein if the matching result satisfies a second preset condition, the advertising information corresponding to the tag is taken as the advertising information matched with the interest information.

In combination with the first aspect, an embodiment of the present disclosure provides an eighth possible example of the first aspect, wherein the second preset condition includes: a condition where the interest information is successfully matched with the tag of the advertising information, with a correlation higher than a preset value.

In combination with the first aspect, an embodiment of the present disclosure provides a ninth possible example of the first aspect, wherein the second preset condition includes: a condition where the tag of the advertising information is successfully matched with the interest information, with a pushing level of the advertising information corresponding to the tag higher than a preset level.

In combination with the first aspect, an embodiment of the present disclosure provides a tenth possible example of the first aspect, wherein, before pushing the advertising information to a client side, it further includes: carrying out semantic analysis on the reading contents corresponding to the access request to obtain emotional tendency of the reading contents, and judging whether the emotional tendency satisfies a third preset condition, wherein if yes, the advertising information is pushed to the client side.

In combination with the first aspect, an embodiment of the present disclosure provides an eleventh possible example of the first aspect, wherein the third preset condition includes a condition where the emotional tendency is not negative.

In a second aspect, an embodiment of the present disclosure further provides an advertising information pushing device, including: an access request acquisition unit, configured to acquire an access request of a user; an interest information acquisition unit, configured to carry out semantic analysis on reading contents corresponding to the access request to obtain interest information of the user; an advertising information matching unit, configured to acquire advertising information matched with the interest information; and an advertising information pushing unit, configured to push the advertising information to the client side.

In combination with the second aspect, an embodiment of the present disclosure provides a first possible example of the second aspect, wherein the interest information acquisition unit specifically includes at least one of: a natural language analysis module, configured to carry out the semantic analysis on the reading contents by natural language processing, with a result of the natural language processing as the interest information; a machine learning analysis module, configured to carry out the semantic analysis on the reading contents by machine learning, with a result of the machine learning as the interest information; a keyword retrieval module, configured to performing retrieval on the reading contents according to one of preset keywords, wherein when a retrieved result satisfies a first preset condition, category tags corresponding to the keyword are taken as the interest information of the user; and a category tag acquisition module, configured to acquire, according to the reading contents, category tags added in advance for the reading contents and take the category tags as the interest information of the user.

In combination with the second aspect, an embodiment of the present disclosure provides a second possible example of the second aspect, wherein it further includes: an emotional tendency acquisition unit, configured to carry out the semantic analysis on the reading contents corresponding to the access request to obtain emotional tendency of the reading contents; an emotional tendency judgment unit, configured to judge whether the emotional tendency satisfies a third preset condition; and the advertising information pushing unit, further configured to push the advertising information to the client side when the judging result of the emotional tendency judgment unit is “yes”.

In a third aspect, an embodiment of the present disclosure further provides an advertising information pushing system, including: a client side and a server; wherein the server is further provided with the advertising information pushing device as described in the second aspect above.

In a fourth aspect, an embodiment of the present disclosure further provides a server, wherein the server includes: a memory, configured to store programs; a processor, configured to, execute, by calling the programs stored in the memory, a method including the following steps: acquiring an access request of a user; carrying out semantic analysis on reading contents corresponding to the access request to obtain interest information of the user; acquiring advertising information matched with the interest information; and pushing the advertising information to a client side.

According to another aspect of the present disclosure, a computer readable medium having non-volatile program codes executable by a processor is provided, and the program codes enable the processor to execute the above method.

Since the advertising information pushing method, device and system, server and computer readable medium provided in the embodiments of the present disclosure, after acquiring a access request of the user, will carry out semantic analysis on the reading contents corresponding to the access request, to obtain the interest information of the user and obtain the advertising information matched with the interest information according to the interest information, so as to push the advertising information to the client, ensuring to a great extent that all the advertisements pushed to the user interest the user, thereby guaranteeing the effectiveness of the advertisements.

In order to make it more obvious and easier to understand the above objects, features, and advantages of the present disclosure, preferable embodiments are particularly illustrated in the following to make detailed description below in conjunction with the accompanying drawings.

### BRIEF DESCRIPTION OF DRAWINGS

In order to more clearly illustrate technical solutions of Embodiments of the present disclosure, figures which are needed for description of the embodiments will be introduced briefly below. It should be understood that the figures below merely show some embodiments of the present disclosure, and therefore should not be considered as a limitation on the scope. A person ordinarily skilled in the art still can obtain other relevant figures according to these figures, without using inventive efforts.

FIG. 1 shows a structural block diagram of a server provided in embodiments of the present disclosure;

FIG. 2 shows a flow chart of an example of an advertising information pushing method provided in embodiments of the present disclosure;

FIG. 3 shows a schematic view of a display interface of the advertising information pushing method provided in embodiments of the present disclosure;

FIG. 4 shows a schematic view of another display interface of the advertising information pushing method provided in embodiments of the present disclosure;

FIG. 5 shows a flow chart of another example of the advertising information pushing method provided in embodiments of the present disclosure;

FIG. 6 shows a structural schematic view of an example of an advertising information pushing device provided in embodiments of the present disclosure;

FIG. 7 shows a specific structural schematic view of an interest information acquisition unit in the advertising information pushing device provided in embodiments of the present disclosure;

FIG. 8 shows a structural schematic view of another example of the advertising information pushing device provided in embodiments of the present disclosure; and

FIG. 9 shows a structural schematic view of an advertising information pushing system provided in embodiments of the present disclosure.

### DETAILED DESCRIPTION OF EMBODIMENTS

In order to make the objects, technical solutions, and advantages of the embodiments of the present disclosure clearer, below the technical solutions in the embodiments of the present disclosure will be described clearly and completely in conjunction with the figures in the embodiments of the present disclosure. Apparently, some but not all embodiments of the present disclosure are described. Generally, components in the embodiments of the present disclosure described and shown in the figures herein can be arranged and designed in different configurations. Therefore, the detailed description below of the embodiments of the present disclosure provided in the figures is not intended to limit the scope of protection of the present disclosure, but merely represents chosen embodiments of the present disclosure. Based on the embodiments of the present disclosure, all the other embodiments, which a person ordinarily skilled in the art obtains without using inventive efforts, fall within the scope of protection of the present disclosure.

At present, there are often the following several methods for pushing advertising information on smart terminals:
1. providing, in a display interface, an advertisement playing position with the position fixed, for example, a lateral side or a lower side of the display interface, and displaying advertising information in a floating manner, or directly embedding the advertisement playing position into the display interface, and playing the preset advertisement at the advertisement playing position;
2. displaying the advertising information in a form of a pop-up page, i.e. when a user clicks the display interface, a pop-up instruction is triggered, and the display interface automatically pops up another display interface which is used to display the preset advertisement; and
3. inserting advertising contents within a content information flow, i.e.

displaying the advertising contents at an uncertain position in the display interface.

However, all of the above advertising information pushing methods require the advertising contents to be played is preset, and when triggered, the advertising information together with the reading contents of the users are directly sent to a client side for displaying. Such advertising information pushing methods in most cases are not needed by the users, therefore, they cannot arouse the interests of the users, and thus the advertising effect cannot meet expectations, resulting in wastes of costs and resources. In view of this, the present disclosure provides advertising information pushing method, device, and system which can push the advertisements according to the interests of the users.

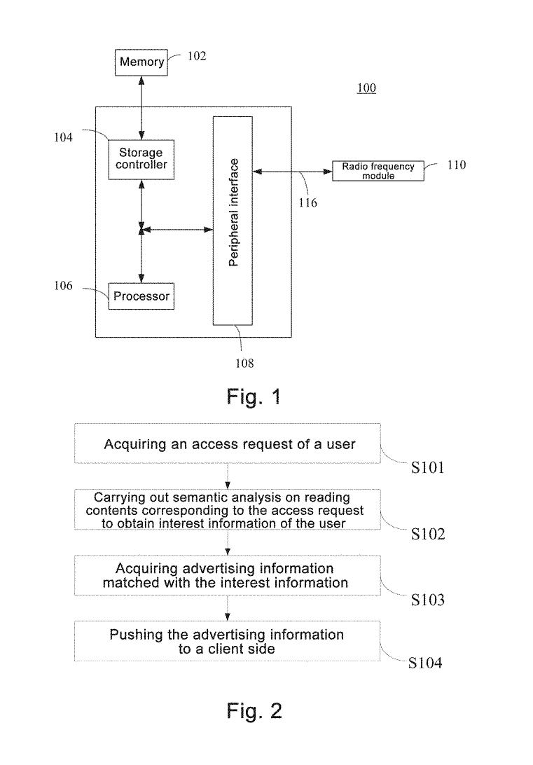

In order to facilitate understanding to the present embodiment, firstly an advertising information pushing method disclosed in an embodiment of the present disclosure is introduced in detail. This method can be applied to a server. FIG. 1 shows a structural block diagram of a server 100 applicable to an embodiment of the present disclosure. As shown in FIG. 1, the server 100 includes a memory 102, a storage controller 104, one or more (only one is shown in the figure) processors 106, a peripheral interface 108, a radio frequency module 110, etc. These components communicate with each other through one or more communication buses/signal lines 116.

The memory 102 may be used to store software programs and modules, such as program instructions/modules corresponding to the advertising information pushing method and device in the embodiments of the present disclosure, the processor 106 executes various functional applications and data processing, such as the advertising information pushing method provided in the embodiment of the present disclosure, by operating software programs and modules stored in the memory 102.

The memory 102 can include a high-speed random access memory, and also can include a non-volatile memory, such as one or more magnetic storing devices, flash memories, or other non-volatile solid state memories. Access of the processor 106 and other possible components to the memory 102 may be carried out under the control of the storage controller 104.

The peripheral interface 108 couples various input/output devices to the processor 106 and the memory 102. In some examples, the peripheral interface 108, the processor 106, and the storage controller 104 may be implemented in a single chip. In some other examples, they may be implemented by individual chips, respectively.

The radio frequency module 110 is used to receive and send electromagnetic waves, and realize interconversion between the electromagnetic waves and electrical signals, so as to communicate with the communication networks or other devices.

It can be understood that the structure shown in FIG. 1 is merely illustrative, while the server 100 may further include more or less components than those shown in FIG. 1, or has a configuration different from that shown in FIG. 1. Various components shown in FIG. 1 may be implemented by hardware, software, or a combination thereof.

With reference to FIG. 2, an example of the advertising information pushing method provided in an embodiment of the present disclosure includes: S101: acquiring an access request of a user.

In specific implementation, the user usually needs to use a client side tool to access the network so as to acquire the information he/she wants to read, for example, the user can carry out the network access through browsers, client sides with various functions such as cellphone applications and computer applications to acquire the information the user wants to read. In the above, the client side tool may be installed in computers, smart cellphones, PADs, and other types of smart terminals having the data processing and displaying functions.

When the user accesses the contents he wants to read, an access request will be firstly send, through the client side, to the server 100, the server 100 acquires corresponding reading contents according to the request sent by the client side and returns corresponding reading contents (literal contents, pictures, photos and articles, videos, etc.) to the client side, and the reading contents acquired by the server 100 according to the access request are the contents the user wants to read. The reading contents are usually of various types, for example, literal contents, pictures, literal contents in combination with pictures, etc.

S102: carrying out semantic analysis on the reading contents corresponding to the access request to obtain interest information of the user.

In specific implementation, the reading contents acquired according to the access request of the user are usually related to a certain topic, for example, news information, shopping information, entertainment information, recruitment information, and so on. Generally, the type of the reading contents accessed by the user indicates the corresponding topic about which the user is relatively concerned, therefore, after acquiring the reading contents of the user, the topic in which the user is interested, i.e. the interest information of the user, can be acquired according to the reading contents of the user.

For example, if the user accesses sports news, the user may be interested in advertisements of sports goods; if the user accesses shopping information of footwear, the user may be interested in advertisements of other footwear selling information; and if the user accesses the recruitment information, the user may be interested in some job recommendation advertisements of the same job.

There are usually the following several ways of carrying out the semantic analysis on the reading contents corresponding to the access request:
1. carrying out the semantic analysis on the reading contents by natural language processing, with a result of the natural language processing as the interest information. Natural language processing (NLP) can enable the server 100 to obtain meaning of a section of natural text, for example, an abstract of a certain section of reading contents can be obtained through the natural language processing technology, and the abstract is the interest information of the user.
2. carrying out the semantic analysis on the reading contents by machine learning, with a result of machine learning as the interest information. Machine learning (ML) can automatically analyze the reading contents to obtain rules, to carry out the natural language processing.
3. performing retrieval on the reading contents according to one of preset keywords, with category tags corresponding to the keyword as the interest information of the user when a retrieved result satisfies the first preset condition. In implementation, the preset keywords are each corresponding to specific category tags, and when the sematic analysis is carried out, the keyword is retrieved in the reading contents, wherein if the preset keyword is retrieved and a first preset condition is satisfied, the specific category tags corresponding to this keyword are taken as the result of semantic analysis.

The first preset condition may be specifically set according to practical needs, for example, that the number of occurrences that a certain keyword is found greater than or equal to a first preset number is taken as the first preset condition, and when the number of the certain keyword appeared in the reading contents is greater than or equal to the first preset number, the category tags corresponding to this keyword are taken as the interest information; alternatively, this keyword is associated with at least one other supplementary keyword, when the number of occurrences that the keyword is found in the reading contents is greater than or equal to a second preset number, the other supplementary keyword associated with this keyword is retrieved in the reading contents, and when the other associated supplementary keywords is also found, the category tags corresponding to this keyword are taken as the interest information. In the above, specific values of the first preset number and the second preset number are not defined in the present embodiment, and the first preset number and the second preset number may be equal or not. In the present embodiment, the second preset number may be one.

For example, football is taken as a keyword, and keywords associated with football may include names of football players, names of football clubs, names of football fields, names of football matches, etc., the category tags corresponding to football may include sports goods, football, gym shoes, athletic shoes, leg guard, etc., and retrieval is performed on the reading contents by using football as the keyword, wherein if the word football is retrieved out from the reading contents and appears the first preset number of times, category tags of football are taken as the interest information of the user; alternatively, retrieval is performed on the reading contents by using football as the keyword, wherein if the word football appears in the reading contents and appears the second preset number of times, retrieval is performed on the reading contents for other associated keywords, wherein if at least one of the other associated keywords also appears, the category tags corresponding to football may be taken as the interest information of the user.
4. adding in advance the reading contents with category tags, i.e. comprehending the reading contents by manual work, or comprehending or carrying out semantic analysis on the reading contents through the above three manners, and adding in advance category tags to each reading content according to the result of comprehension or semantic analysis, wherein when the reading contents are acquired, the category tags corresponding to the reading contents can be obtained directly through the reading contents, and the category tags corresponding to the reading contents are taken as the interest information of the user.
5. Others. When providing a specific access service, the server 100 usually will have its own definition to the access service it provides. Taking a certain portal website for example, the server 100 for providing information often will specifically classify messages according to the types of the messages the website releases, and also make, during classification, more specific, more multilevel division, for example, dividing the messages it provides into: news, finance and economics, science and technologies, sports, entertainments, automobiles, blogs, house property, fashions, education, tourism, games, etc., wherein News are divided into military, social, international news, etc., the sports are divided into NBA (National Basketball Association), Chinese Football Association Super League, Premier League, etc. Even in different stages, the categories into which they are divided are also different. When the server 100 acquires the access request of the user, and acquires the reading contents according to the access request, the server also will obtain the relevant categories of the reading contents, wherein as to each category, this category can be taken as the interest information of the user.

S103: acquiring advertising information matched with the interest information.

In specific implementation, at least one tag is required to be added in advance to the advertising information to be pushed, for example, tags for footwear advertisements may include: tags according to genders (men's shoes, women's shoes, children's shoes), tags according to purposes (running, football, basketball), tags according to styles (thigh boots, ankle boots, sandals), tags according to materials (leather, PU, rubber, cloth), etc..

After the interest information of the user is acquired, matching is performed between the interest information and these tags, wherein when the matching result satisfies the second preset condition, the advertising information corresponding to these tags is considered to be matched with the acquired interest information.

Generally, the second preset condition also may be specifically set according to practical situations. For example, the second preset condition may be satisfied when the interest information is successfully matched with the advertising information, with a correlation higher than a preset value; or that the tag of the advertising information is successfully matched with the interest information, with a pushing level of the advertising information corresponding to this tag higher than a preset level.

Specifically, association relationships between certain pieces of set interest information and tags of advertising information can be established in advance (the association relationships also may not be set in advance, but semantic match is directly carried out), moreover, this association relationship may be not in one-to-one correspondence, but intersectional, for example, a tag of a certain advertisement may be corresponding to a plurality of pieces of interest information, and a certain piece of interest information also may be corresponding to a plurality of tags. During matching, since the acquired interest information of the user may be in plurality of pieces, the plurality of pieces of interest information are required to be matched one by one, and finally a plurality of pieces of advertising information may be obtained. Then among the obtained plurality of pieces of advertising information, the advertising information, with the highest matching degree (the semantically more similar the tag and the interest information are, the higher the matching degree is, and/or the more the number of times for successful matching between the tag and the interest information is, the higher the matching degree is), is taken as the advertising information matched with the interest information, that is, the advertising information with the highest matching degree among the obtained plurality of pieces of advertising information is taken as the advertising information to be pushed, i.e. the advertising information is ranked according to correlations, and advertising information with a higher correlation is pushed to the user, and the pushed advertising information with a higher correlation may be the advertising information with a correlation higher than a preset value. Alternatively, according to pushing levels set in advance for the advertising information, the advertising information with a higher pushing level among them is taken as the advertising information matched with the interest information, that is, the advertising information with a higher pushing level among them is pushed to the user, wherein the advertising information with a higher pushing level may be the advertising information whose pushing level is higher than the preset level. Alternatively, the advertising information also can be pushed to the user in a combined manner of the pushing level and the correlation, wherein the preset value of the correlation and the value of the preset level of the pushing level are not specifically defined in the present embodiment, and they can be set according to practical situations.

Besides, when the advertising information needs to be pushed to the user according to the pushing level of the advertising information, the pushing levels of the advertising information should be firstly graded. The pushing levels can be specifically graded according to practical situations, for example, ranking by advertisement auction, according to importance of advertisers, etc., and they are not defined in the present embodiment.

S104: pushing the advertising information to the client side.

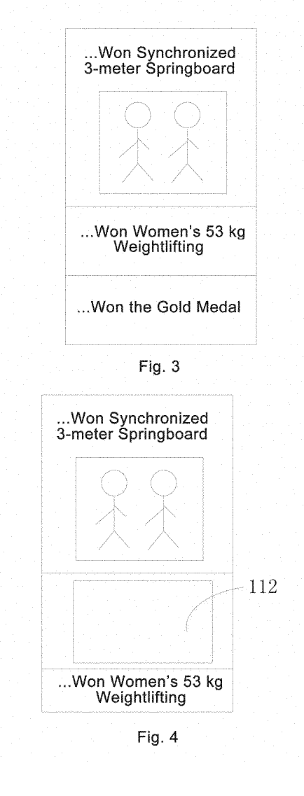

The obtained advertising information matched with the interest information is pushed to the client side. When the advertising information is pushed to the client side, the client side has different manners for processing the advertising information:
1. displaying or playing the advertisement to the user in a form of a pop-up page;
2. inserting the advertising information in an information flow interface displayed to the user when the user initiates the access request, and displaying or playing, when the user again returns to this information flow interface, the advertisement to the user at a specific position. for example, displaying or playing, when the user reads news using a cellphone browser and when the user clicks the button “Back”, the advertisement at a specific position in the returned interface, for example, below the accessed information flow, as shown in FIG. 3 and FIG. 4. For example, FIG. 3 represents a certain news interface read by a user, when the user clicks a certain piece of information in this news interface to view, for example, clicks the first piece “. . . Won Synchronized 3-meter Springboard” in FIG. 3, a sports news, and when the user returns from this news back to the news interface, the advertising information corresponding to the information accessed by the user is inserted in the news interface, for example, 112 shown in FIG. 4 represents an inserted advertisement, which advertisement may be sports brand advertisement corresponding to “. . . Won Synchronized 3-meter Springboard”. Of course, the specific inserting position of the advertisement is not defined in the present embodiment, and the inserting position shown in FIG. 4 is merely illustrative.
3. when the user again initiates to the server 100 an access request of a certain piece of reading information, the server 100 returning new reading contents to the client side according to the new access request, and the client side performing displaying according to the new reading contents, and simultaneously displaying or playing the advertisement in a display interface of the new reading contents.

Since the advertising information pushing method provided in the embodiment of the present disclosure, after acquiring the access request of the user, will carry out semantic analysis on the reading contents corresponding to the access request, to obtain the interest information of the user and obtain the advertising information matched with the interest information according to the interest information so as to push the advertising information to the client, that all the advertisements pushed to the user interest the user are ensured to a great extent, guaranteeing the effectiveness of the advertisements.

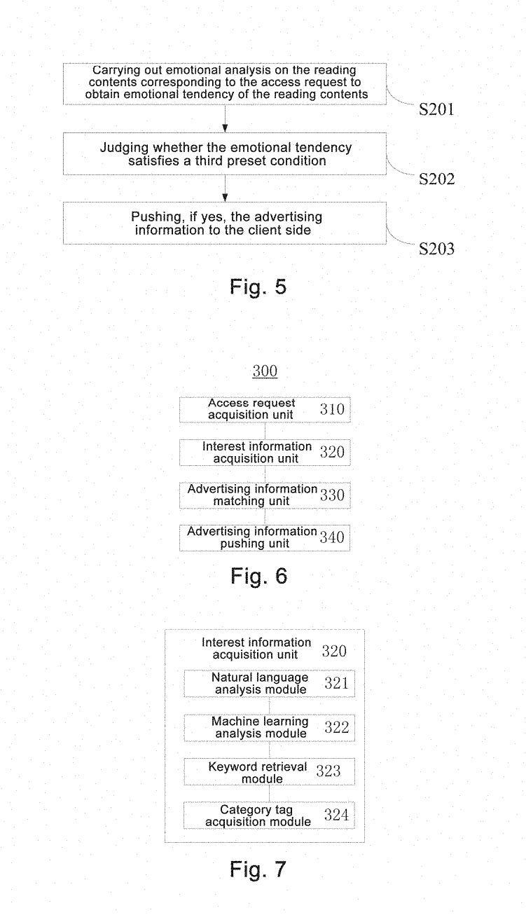

In addition, on the basis of the above embodiment, with reference to FIG. 5, the advertising information pushing method provided in the embodiment of the present disclosure further includes another example, which, before pushing the advertising information to the client side, can further include:

S201: carrying out emotional analysis on the reading contents corresponding to the access request to obtain emotional tendency of the reading contents.

The emotional analysis on the reading contents can be specifically carried out in the following several ways:
1. marking preset vocabulary with an emotional tag, particularly, setting a certain category of vocabulary with apparent emotions, for example, vocabulary of disasters, vocabulary of accidents, etc. When the emotional analysis is carried out, retrieval may be performed on the reading contents by using the preset vocabulary as keywords, wherein if the number of the vocabulary retrieved is greater than a preset number, the emotional tendency of the reading contents is considered to be corresponding to the emotional tag marked for the vocabulary.
2. using a natural language understanding model to carry out emotional analysis on the reading contents, wherein the final analysis result is the emotional tendency of the reading contents.

S202: judging whether the emotional tendency satisfies a third preset condition; and

S203: pushing, if yes, the advertising information to the client side.

In specific implementation, the third preset condition can be specifically set according to practical situations, for example, that the emotional tendency is not negative is taken as the third preset condition, wherein if the emotional tendency of the reading contents is negative, for example, some reading contents are related to disasters, it is unsuitable to play advertisements, at this time, the advertisements will not be played; only when the emotional tendency is not negative, the advertising information is pushed to the client side. Besides, whether pushing the advertising information also can be judged according to different degrees of the emotional tendency, for example, number of times of appearance of certain keywords is different, then the degrees of emotional tendency of the reading contents can be considered different, wherein the correspondence relationship between the specific number of times and the degree of emotional tendency can be determined according to practical situations. Alternatively, emotional tags of different degrees of emotional tendency are set according to the actual emotional intensity of the vocabulary, for example, the negative degree of the emotional tag “unhappy” is less than the negative degree of the emotional tag of “sad”, the negative degree of the emotional tag of “sad” is less than the negative degree of the emotional tag of “sorrow”, and so on. The specific degree of emotional tendency corresponding to the third preset condition is not defined in the present embodiment, and can be determined according to practical situations.

Besides, the emotional analysis on the reading contents also can be carried out before carrying out the semantic analysis on the reading contents corresponding to the access request to obtain the interest information of the user, in this way, when the emotional tendency does not satisfy the third preset condition, the subsequent processes may not be executed, saving the resources of the server 100, and reducing the pressure of the server 100.

Another embodiment of the present disclosure further provides an advertising information pushing device 300, as shown in FIG. 6, an example of the advertising information pushing device 300 provided in the embodiment of the present disclosure, including: an access request acquisition unit 310, configured to acquire an access request of a user; an interest information acquisition unit 320, configured to carry out semantic analysis on reading contents corresponding to the access request to obtain interest information of the user; an advertising information matching unit 330, configured to acquire advertising information matched with the interest information; and an advertising information pushing unit 340, configured to push the advertising information to the client side.

In the present embodiment, for specific functions and interacting manners of the access request acquisition unit 310, the interest information acquisition unit 320, the advertising information matching unit 330, and the advertising information pushing unit 340, reference can be made to the description of the embodiment corresponding to FIG. 2, and unnecessary details will not be given herein.

Since the advertising information pushing device 300 provided in the embodiment of the present disclosure, after acquiring the access request of the user, will carry out semantic analysis on the reading contents corresponding to the access request to obtain the interest information of the user, and obtain the advertising information matched with the interest information according to the interest information, so as to push the advertising information to the client, ensuring to a great extent that all the advertisements pushed to the user interest the user, thereby guaranteeing the effectiveness of the advertisements.

With reference to FIG. 7, in the advertising information pushing device provided in an embodiment of the present disclosure, the interest information acquisition unit 320 specifically includes at least one of: a natural language analysis module 321, configured to carry out the semantic analysis on the reading contents by natural language processing, with a result of the natural language processing as the interest information; a machine learning analysis module 322, configured to carry out the semantic analysis on the reading contents by machine learning, with a result of the machine learning as the interest information; a keyword retrieval module 323, configured to perform retrieval on the reading contents according to one of preset keywords, and take, when a retrieved result satisfies a first preset condition, category tags corresponding to this keyword as the interest information of the user; and a category tag acquisition module 324, configured to acquire, according to the reading contents, the category tags added in advance to the reading contents, and take the category tags as the interest information of the user.

In the above, the first preset condition may be satisfied when the number of occurrences that the keyword is found in the reading contents is greater than or equal to the first preset number, or when each keyword is also associated with at least one supplementary keyword and the number of occurrences that the keyword is found in the reading contents is greater than or equal to the second preset number and the reading contents at least include at least one supplementary keyword. The specific content of the first preset condition is not limited in the present embodiment, and it can be set as required.

Further, in the present embodiment, a tag addition unit may be further included, configured to add in advance at least one tag to each piece of advertising information. In the above, the advertising information matching unit 330 can include a matching module, configured to match the interest information with the tag of the advertising information; and an advertising information confirmation module, configured to, take, if the matching result satisfies the second preset condition, the advertising information corresponding to the tag as the advertising information matched with the interest information.

Specifically, the advertising information confirmation module can be configured to take the following as the second preset condition: the interest information is successfully matched with the tag of the advertising information with a higher correlation than the preset value, or configured to take the following as the second preset condition: the tag of the advertising information is successfully matched with the interest information, with a pushing level of the advertising information corresponding to this tag being higher than the preset level.

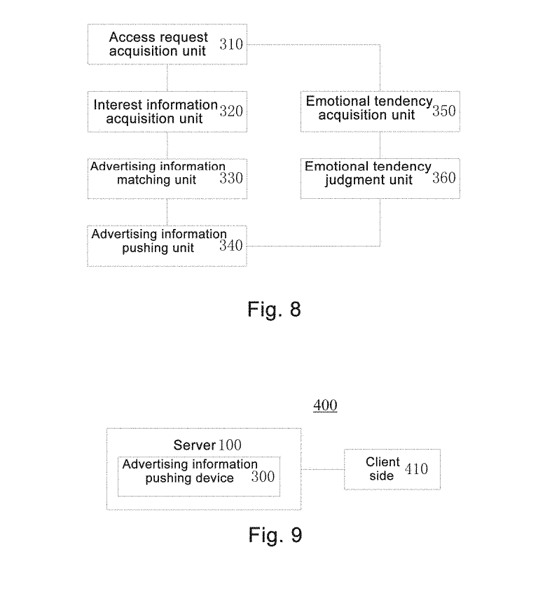

With reference to FIG. 8, another example of the advertising information pushing device 300 is provided in an embodiment of the present disclosure, and in this example, the advertising information pushing device 300 further includes: an emotional tendency acquisition unit 350, configured to carry out semantic analysis on the reading contents corresponding to the access request to obtain the emotional tendency of the reading contents; an emotional tendency judgment unit 360, configured to judge whether the emotional tendency satisfies the third preset condition; and the advertising information pushing unit 340 further configured to push the advertising information to the client side when the judging result of the emotional tendency judgment unit is “yes”.

In the above, the emotional tendency judgment unit 360 can be configured to take that the emotional tendency is not negative as the third preset condition.

In the present embodiment, for the specific functions and interacting manners of the access request acquisition unit 310, the interest information acquisition unit 320, the advertising information matching unit 330, the advertising information pushing unit 340, the emotional tendency acquisition unit 350, and the emotional tendency judgment unit 360, reference can be made to the description of the embodiment corresponding to FIG. 5, and unnecessary details will not be given herein.

Another embodiment of the present disclosure further provides an advertising information pushing system 400, with reference to FIG. 9, including a client side 410 and a server 100.

The server 100 is further provided with the advertising information pushing device 300 as in the above embodiment.

Computer program products of the advertising information pushing method, device, and system provided in the embodiments of the present disclosure include a computer readable storage medium stored with program codes, wherein instructions included in the program codes can be used to execute the method in the preceding method embodiment. Reference can be made to the method embodiment for the specific implementation, and unnecessary details will not be given herein.

A person skilled in the art should clearly know that for the sake of descriptive convenience and conciseness, reference can be made to a corresponding process of the previous method embodiment for specific working processes of the system and device described above, and unnecessary details will not be given herein.

A function, which can be realized in a form of software functional unit and sold or used as an individual product, can be stored in one computer readable storage medium. Based on such understanding, essentially, the technical solutions of the present disclosure, the parts making contribution to the prior art or parts of this technical solutions can be embodied in a form of a software product, and this computer software product is stored in one storage medium, and includes several instructions used to make one computer device (which may be a personal computer, a sever or a network device etc.) execute all or part of the steps of the methods of various embodiments of the present disclosure. The aforementioned storage medium includes various media that can store program codes, such as U disks, mobile hard disks, Read-Only Memories (ROMs), Random Access Memories (RAMs), diskettes or compact disks and so on.

The above are merely for specific examples of the present disclosure, while the scope of protection of the present disclosure is not limited thereto. Any variations or substitutions, that would readily occur to any skilled person familiar with the prior art, should fall into the scope of protection of the present disclosure. Therefore, the scope of protection of the present disclosure should be determined by the scope of protection of the claims.

### INDUSTRIAL APPLICABILITY

Since the advertising information pushing method, device and system, server, computer readable medium provided in the embodiments of the present disclosure, after acquiring the access request of the user, will carry out semantic analysis on the reading contents corresponding to the access request to obtain the interest information of the user, and obtain the advertising information matched with the interest information according to the interest information, so as to push the advertising information to the client, ensuring to a great extent that all the advertisements pushed to the user interest the user, thereby guaranteeing the effectiveness of the advertisements.

1. An advertising information pushing method, wherein comprising:
acquiring an access request of a user;
carrying out semantic analysis on reading contents corresponding to the access request to obtain interest information of the user;
acquiring advertising information matched with the interest information;
carrying out semantic analysis on reading contents corresponding to the access request to obtain emotional tendency of the reading contents;
judging whether the emotional tendency satisfies a third preset condition; and
executing, as a function of the third preset condition being satisfied, a process of pushing the advertising information to a client side, wherein the pushing comprises displaying or playing, when the user clicks “back” after reading is completed, advertisements at a specific position in a return interface.

2. The method according to claim 1, wherein the step of carrying out semantic analysis on reading contents corresponding to the access request comprises:
carrying out the semantic analysis on the reading contents by natural language processing, with a result of the natural language processing as the interest information:, and/or
carrying out the semantic analysis on the reading contents by machine learning, with a result of the machine learning as the interest information; and/or
performing retrieval on the reading contents according to preset keywords, with category tags corresponding to the keyword as the interest information of the user when a retrieved result satisfies a first preset condition; and/or
acquiring, according to the reading contents, category tags added in advance to the reading contents, with the category tags of the reading contents as the interest information of the user.

3.-4. (canceled)

5. The method according to claim 1, wherein the first preset condition comprises:
a condition where number of occurrences that the keyword is found in the reading contents is greater than or equal to a preset number; or
a condition where each keyword is further associated with at least one supplementary keyword; and number of occurrences that the keyword is found in the reading contents is greater than or equal to a preset number, and the reading contents at least include one supplementary keyword.

6.-7. (canceled)

8. The method according to claim 1, further comprising:
adding in advance at least one tag to each piece of advertising information;
wherein the step of acquiring advertising information matched with the interest information comprises:
matching the interest information with the tag of the advertising information, wherein if the matching result satisfies a second preset condition, the advertising information corresponding to the tag is taken as the advertising information matched with the interest information.

9. The method according to claim 8, wherein the second preset condition comprises:
a condition where the interest information is successfully matched with the tag of the advertising information, with a correlation higher than a preset value; and/or
a condition where the tag of the advertising information is successfully matched with the interest information, with a pushing level of the advertising information corresponding to the tag higher than a preset level.

10.-12. (canceled)

13. An advertising information pushing device, the device comprising:
an access request acquisition unit configured to acquire an access request of a user;
an interest information acquisition unit configured to carry out semantic analysis on reading contents corresponding to the access request to obtain interest information of the user;
an advertising information matching unit configured to acquire advertising information matched with the interest information; and
an advertising information pushing unit configured to push the advertising information to the client side, wherein the pushing comprises displaying or playing, when the user clicks “back” after reading is completed, advertisements at a specific position in a return interface;
wherein the advertising information pushing device further comprises an emotional tendency judgment unit, configured to carry out the semantic analysis on the reading contents corresponding to the access request to obtain emotional tendency of the reading contents;
wherein the emotional tendency judgment unit is configured to judge whether the emotional tendency satisfies the third preset condition; and
wherein the advertising information pushing unit is further configured to push the advertising information to the client side when the judging result of the emotional tendency judgment unit is “yes”.

14. The device according to claim 13, wherein the interest information acquisition unit comprises:
a natural language analysis module configured to carry out the semantic analysis on the reading contents by natural language processing, with a result of the natural language processing as the interest information; and/or
a machine learning analysis module, configured to carry out the semantic analysis on the reading contents by machine learning, with a result of the machine learning as the interest information; and/or
a keyword retrieval module, configured to perform retrieval on the reading contents according to preset keywords, with category tags corresponding to the keyword as the interest information of the user when a retrieved result satisfies a first preset condition; and/or
a category tag acquiring module, configured to acquire, according to the reading contents, category tags added in advance to the reading contents, with the category tags as the interest information of the user.

15.-16. (canceled)

17. An advertising information pushing system, comprising: a client side and a server;
wherein the server is further provided with the advertising information pushing device of claim 13.

18. (canceled)

19. The method according to claim 2, further comprising:
adding in advance at least one tag to each piece of advertising information;
wherein the step of acquiring advertising information matched with the interest information comprises:
matching the interest information with the tag of the advertising information, wherein if the matching result satisfies a second preset condition, the advertising information corresponding to the tag is taken as the advertising information matched with the interest information.

20. The method according to claim 19, wherein the second preset condition comprises:
a condition where the interest information is successfully matched with the tag of the advertising information, with a correlation higher than a preset value; and/or
a condition where the tag of the advertising information is successfully matched with the interest information, with a pushing level of the advertising information corresponding to the tag higher than a preset level.

21. The method according to claim 5, further comprising:
adding in advance at least one tag to each piece of advertising information;
wherein the step of acquiring advertising information matched with the interest information comprises:
matching the interest information with the tag of the advertising information, wherein if the matching result satisfies a second preset condition, the advertising information corresponding to the tag is taken as the advertising information matched with the interest information.

22. The method according to claim 21, wherein the second preset condition comprises:
a condition where the interest information is successfully matched with the tag of the advertising information, with a correlation higher than a preset value; and/or
a condition where the tag of the advertising information is successfully matched with the interest information, with a pushing level of the advertising information corresponding to the tag higher than a preset level.

23. An advertising information pushing system, comprising: a client side, and a server;
wherein the server is further provided with the advertising information pushing device of claim 14.
